(19) United States
(12) Patent Application Publication
(10) Pub. No.: US 2009/0076092 A1
(43) Pub. Date: Mar. 19, 2009

(54) METHOD FOR DISRUPTING REPRODUCTIVE PERFORMANCE OF ARTHROPODS

(76) Inventors: Issac Billy Annan, Newark, DE (US); John Lindsey Flexner, Landenberg, PA (US); Paula Cristina Rodrigues Gouveia Marcon, Elkton, MD (US); Hector Eduardo Portillo, Bear, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/282,212

(22) PCT Filed: Mar. 20, 2007
(86) PCT No.: PCT/US07/06929

§ 371 Date: Sep. 9, 2008

Related U.S. Application Data
(60) Provisional application No. 60/787,753, filed on Mar. 31, 2006.

(51) Int. Cl. A01N 37/18; A01N 43/56; A01N 43/40; A01P 7/00

(52) U.S. Cl. 514/341; 514/406; 514/616

(57) ABSTRACT

Disclosed is a method for disrupting reproductive performance of an adult arthropod pest comprising contacting the adult arthropod pest or its environment with a sub-lethal, reproduction-disruptive amount of a carboxamide arthropodicide, its N-oxide, or a salt thereof.

### FIELD OF THE INVENTION

This invention relates to a method for disrupting reproductive performance of arthropod pests comprising contacting the arthropod pests or their environment with a sub-lethal, reproduction-disruptive amount of a carboxamide arthropodicide, its N-oxide, or salt thereof.

### BACKGROUND OF THE INVENTION

The control of arthropod pests is extremely important in achieving high crop efficiency. The control of arthropod pests in forestry, greenhouse crops, ornamentals, nursery crops, stored food and fiber products, livestock, household, turf, wood products, and public and animal health is also important. Arthropod damage to growing and stored agronomic crops can cause significant reduction in productivity and thereby result in increased costs to the consumer.

Methods for controlling arthropods often entail application of an arthropodicide to the pest or its environment at a lethal dosage. Repeated exposure to the same arthropodicide may result in the selection of individuals resistant to the arthropodicide, and can lead to the development of resistant populations. Resistance to chemical insecticides such as organochlorides, organophosphates, carbamates, spinosyns and pyrethroids is known.

Alternative control methods involve reducing pest reproductive performance such as through mating disruption, in which insect sex pheromones are used to partially or fully replace arthropodicides for protecting agricultural crops and forests against arthropod pests. Once the mating of pests is effectively disrupted, although the population of the treated cohort colonies may not be immediately reduced, secondary infestations of the progeny of the cohort generation are significantly reduced along with potential crop damage. However, drawbacks of using insect pheromones include instability of the pheromones as well as complex formulation and releasing methods required for optimum results, which often results in less than desired efficacy.

Anthranilamides (see U.S. Pat. No. 6,747,047, PCT Publications WO 2003/015518 and WO 2004/067528) and phthalic diamides (see U.S. Pat. No. 6,603,044) are recently discovered classes of carboxamide arthropodicides having activity against numerous arthropod pests of economic importance. These publications disclose tests in which carboxamides control arthropods by causing mortality. To achieve an economic level of pest control through mortality typically requires application of a pesticide at a concentration killing at least 80% of the target pest (i.e. LC₈₀).

Remarkably, a method has now been discovered to effectively control arthropod pest populations using carboxamide arthropodicides to achieve effects similar to pheromones but without their drawbacks.

### SUMMARY OF THE INVENTION

This invention pertains to a method for disrupting reproductive performance of an adult arthropod pest comprising contacting the adult arthropod pest or its environment with a sub-lethal, reproduction-disruptive amount of a carboxamide arthropodicide, its N-oxide, or salt thereof, provided that the adult arthropod pest is other than Cydia pomonella or Grapholita molesta.

This invention also relates to a method wherein the carboxamide arthropodicide, its N-oxide, or a salt thereof, is formulated as a composition comprising the arthropodicide, its N-oxide, or a salt thereof, and at least one additional component selected from the group consisting of surfactants and liquid diluents.

### DETAILS OF THE INVENTION

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “adult arthropod pest” refers to the adult growth stage, which is the reproductive stage of the arthropod pest. Most arthropods go through different growth/development stages, some involving abrupt and pronounced change in body forms; the term describing these changes as the arthropods mature is known as metamorphosis. Four kinds of metamorphosis have been described: anamorphosis, ametabolous, incomplete metamorphosis, and complete metamorphosis. No matter what kind of metamorphosis of an arthropod species, “adult arthropod” means that the arthropod has reached the adult growth stage; i.e. its sexual organs are fully developed, it can display mating, oviposition and other forms of reproductive behaviors, and can reproduce to produce offspring of the subsequent generation. Therefore, the method of the present invention relates to contact of arthropods at the “adult” reproductive growth stage of the arthropods, i.e. “adult arthropods”, with a sub-lethal, reproduction-disruptive amount of a carboxamide arthropodicide.

The term “arthropod pest” includes insects, mites and ticks that are pests of growing or stored agronomic crops, forestry, greenhouse crops, ornamentals, nursery crops, stored food or fiber products, livestock, houses and other buildings or injurious to public and animal health. In the context of this disclosure, “controlling an arthropod pest” means disrupting the reproductive performance of the treated adult pests, including hindering copulations, or producing fewer eggs by the female or less viable offspring, thus reducing secondary infestations.

The term “sub-lethal concentration, “sub-lethal dose” or “sub-lethal amount” in the context of the present invention means a concentration or dose or amount causing about 50% or less mortality (<LC₅₀ or LD₅₀); in other words, at least about 50% of the population are alive after the treatment.

Mating disruption is a phenomenon or an effect that results in the impairment of the ability of male and female pests to attract each other for mating, or even if they do locate each other they cannot successfully copulate. This results in no reproduction at all by the female, or reduced number of eggs or live births (according to mode of reproduction), or reduced viability of any offspring as manifested by their survival, longevity or growth and development. Examples of natural products that cause disruption in insect mating behavior include sex pheromones and other semiochemicals (a general reference for pheromones and semiochemicals is The BioPesticide Manual, Second Edition, L. G. Copping, Ed., British Crop Protection Council, Farnham, Surrey, U. K., 2001).

In the context of the present disclosure, the term “fertility” refers to the viability and fitness of the offspring produced by a female pest. In this case, it is commonly measured by life performance parameters, such as longevity, development time, body weight, and presence or absence of morphological abnormalities. The effects of a chemical on pest fertility parameters are generally manifested in the growth, development and life performance parameters of the offspring of the treated adults.

The term “fecundity” as used in this disclosure refers to the total number of eggs or live offspring produced by female arthropods. In general, it defines the number of the progeny produced by the female arthropods.

The term “disrupting reproductive performance” includes disruption of mating, adverse effects on fertility or fecundity, either separately or in combination, or any permutations thereof. The term “reproduction-disruptive amount”, “reproduction-disruptive dose” or “reproduction-disruptive concentration”, by this definition, means an amount, dose or concentration disrupting reproductive performance of treated arthropod pests and thereby reducing the offspring population of the treated arthropod pests.

As is well known in the art, the term “carboxamide” refers to a moiety comprising a carbon, nitrogen and oxygen atom bonded in the configuration shown as Formula A. The carbon atom in Formula A is bonded to a carbon atom in a radical to which the carboxamide moiety is bonded. The nitrogen atom in Formula A is bonded to the carbonyl carbon of Formula A and also bonded to two other atoms, at least one atom of which is selected from a hydrogen atom or a carbon atom of another radical to which the carboxamide moiety is bonded.

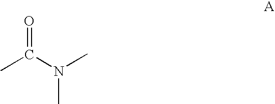

In one embodiment the carboxamide arthropodicide of the present method contains at least two carboxamide moieties. In another embodiment the carboxamide arthropodicide contains at least two carboxamide moieties vicinally bonded to carbon atoms (i.e. in ortho arrangement) of a carbocyclic or heterocyclic ring. In a further embodiment the carbocyclic or heterocyclic ring of the at least one carboxamide arthropodicide is aromatic (i.e. satisfies the Hückel 4n+2 rule for aromaticity).

Embodiments of the present invention include:

### EMBODIMENT 1

The method described in the Summary of the Invention wherein the carboxamide arthropodicide is selected from anthranilamides of Formula 1, N-oxides, and salts thereof,

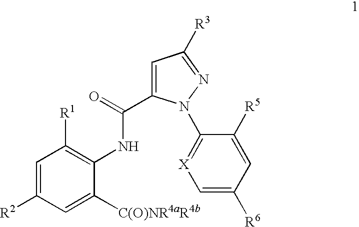

wherein

X is N, CF, CCl, CBr or CI;

R¹ is CH₃, Cl, Br or F;

R² is H, F, Cl, Br or CN;

R³ is F, Cl, Br, C₁-C₄ haloalkyl or C₁-C₄ haloalkoxy;

R^{4a} is H, C₁-C₄ alkyl, cyclopropylmethyl or 1-cyclopropylethyl;

R^{4b} is H or CH₃;

R⁵ is H, F, Cl or Br; and

R⁶ is H, F, Cl or Br.

### EMBODIMENT 1A

The method of Embodiment 1 wherein X is N; R¹ is CH₃; R² is Cl or CN; R³ is Cl, Br or CF₃; R^{4a} is C₁-C₄ alkyl; R^{4b} is H; R⁵ is Cl; and R⁶ is H.

### EMBODIMENT 1B

The method of Embodiment 1 wherein X is N; R¹ is CH₃; R² is Cl or CN; R³ is Cl, Br or CF₃; R^{4a} is Me or CH(CH₃)₂; R^{4b} is H; R⁵ is Cl; and R⁶ is H.

### EMBODIMENT 1C

The method of Embodiment 1 wherein the carboxamide arthropodicide is selected from the group consisting of:
N-[4-chloro-2-methyl-6-[[(1-methylethyl)amino]carbonyl]phenyl]-1-(3-chloro-2-pyridinyl)-3-(trifluoromethyl)-1H-pyrazole-5-carboxamide,
N-[4-chloro-2-methyl-6-[(methylamino)carbonyl]phenyl]-1-(3-chloro-2-pyridinyl)-3-(trifluoromethyl)-1H-pyrazole-5-carboxamide,
3-bromo-N-[4-chloro-2-methyl-6-[[(1-methylethyl)amino]carbonyl]phenyl]-1-(3-chloro-2-pyridinyl)-1H-pyrazole-5-carboxamide,
3-bromo-N-[4-chloro-2-methyl-6-[(methylamino)carbonyl]phenyl]-1-(3-chloro-2-pyridinyl)-1H-pyrazole-5-carboxamide,
3-bromo-1-(3-chloro-2-pyridinyl)-N-[4-cyano-2-methyl-6-[(methylamino)-carbonyl]phenyl]-1H-pyrazole-5-carboxamide,
1-(3-chloro-2-pyridinyl)-N-[4-cyano-2-methyl-6-[(methylamino)carbonyl]-phenyl]-3-(trifluoromethyl)-1H-pyrazole-5-carboxamide,
3-bromo-1-(2-chlorophenyl)-N-[4-cyano-2-methyl-6-[[(1-methylethyl)amino]-carbonyl]phenyl]-1H-pyrazole-5-carboxamide,
3-bromo-1-(2-chlorophenyl)-N-[4-cyano-2-methyl-6-[(methylamino)carbonyl]-phenyl]-1H-pyrazole-5-carboxamide,
3-bromo-1-(2-chlorophenyl)-N-[2,4-dichloro-6-[(methylamino)carbonyl]-phenyl]-1H-pyrazole-5-carboxamide,
3-bromo-N-[4-chloro-2-[[(cyclopropylmethyl)amino]carbonyl]-6-methyl-phenyl]-1-(3-chloro-2-pyridinyl)-1H-pyrazole-5-carboxamide,
3-bromo-1-(3-chloro-2-pyridinyl)-N-[4-cyano-2-[[(cyclopropylmethyl)amino]-carbonyl]-6-methylphenyl]-1H-pyrazole-5-carboxamide,
3-bromo-N-[4-chloro-2-[[(1-cyclopropylethyl)amino]carbonyl]-6-methyl-phenyl]-1-(3-chloro-2-pyridinyl)-1H-pyrazole-5-carboxamide, and
3-bromo-1-(3-chloro-2-pyridinyl)-N-[4-cyano-2-[[(1-cyclopropylethyl)amino]-carbonyl]-6-methylphenyl]-1H-pyrazole-5-carboxamide.

### EMBODIMENT 2

The method described in the Summary of the Invention wherein the carboxamide arthropodicide is selected from phthalic diamides of Formula 2 and salts thereof,

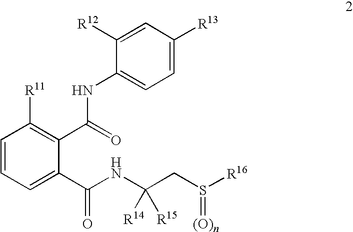

wherein

R¹¹ is CH₃, Cl, Br or I;

R¹² is CH₃ or Cl;

R¹³ is C₁-C₃ fluoroalkyl;

R¹⁴ is H or CH₃;

R¹⁵ is H or CH₃;

R¹⁶ is C₁-C₂ alkyl; and

n is 0, 1 or 2.

### EMBODIMENT 2B

The method of Embodiment 2 wherein R¹¹ is Cl, Br or I; R¹² is CH₃; R¹³ is CF₃, CF₂CF₃ or CF(CF₃)₂; R¹⁴ is H or CH₃; R¹⁵ is H or CH₃; R¹⁶ is CH₃; and n is 0, 1 or 2.

### EMBODIMENT 2C

The method of Embodiment 2 wherein the carboxamide arthropodicide is N²-[1,1-dimethyl-2-(methylsulfonyl)ethyl]-3-iodo-N¹-[2-methyl-4-[1,2,2,2-tetrafluoro-1-(trifluoromethyl)ethyl]phenyl]-1,2-benzenedicarboxamide.

### EMBODIMENT 3

The method described in the Summary of the Invention wherein the arthropod pest is a species of the order Hemiptera.

### EMBODIMENT 3A

The method of Embodiment 3 wherein the arthropod pest is a species in one of the families Aleyrodidae, Aphididae, and Cicadellidae.

### EMBODIMENT 3B

The method of Embodiment 3 wherein the arthropod pest is Bemisia argentifolii.

### EMBODIMENT 3C

The method of Embodiment 3 wherein the arthropod pest is Myzus persicae.

### EMBODIMENT 3D

The method of Embodiment 3 wherein the arthropod pest is Nephotettix virescens.

### EMBODIMENT 4

The method described in the Summary of the Invention wherein the arthropod pest is a species of the order Thysanoptera.

### EMBODIMENT 4A

The method of Embodiment 4 wherein the species is in the family Thripidae.

### EMBODIMENT 4B

The method of Embodiment 4 wherein the arthropod pest is Frankliniella occidentalis.

### EMBODIMENT 5

The method described in the Summary of the Invention wherein the arthropod pest is a species of the order Coleoptera.

### EMBODIMENT 5A

The method of Embodiment 5 wherein the arthropod pest is a species in the family Chrysomelidae.

### EMBODIMENT 5B

The method of Embodiment 5 wherein the arthropod pest is Leptinotarsa decemlineata.

### EMBODIMENT 5C

The method described in the Summary of the Invention wherein the arthropod pest is other than Leptinotarsa decemlineata.

### EMBODIMENT 6

The method described in the Summary of the Invention wherein the arthropod pest is a species of the order Lepidoptera.

### EMBODIMENT 6A

The method of Embodiment 6 wherein the arthropod pest is a species in one of the families Noctuidae and Plutellidae.

### EMBODIMENT 6B

The method of Embodiment 6 wherein the arthropod pest is Spodoptera exigua.

### EMBODIMENT 6C

The method of Embodiment 6 wherein the arthropod pest is Plutella xylostella.

### EMBODIMENT 6D

The method of Embodiment 6 wherein the arthropod pest is Helicoverpa armigera.

### EMBODIMENT 6E

The method described in the Summary of the Invention wherein the arthropod pest is other than Plutella xylostella.

### EMBODIMENT 7

The method described in the Summary of the Invention wherein the arthropod pest is a species of the order Diptera.

### EMBODIMENT 7A

The method of Embodiment 7 wherein the arthropod pest is a species in one of the families Tephritidae and Muscidae.

### EMBODIMENT 7B

The method of Embodiment 7 wherein the arthropod pest is Musca domestica.

In the above recitations, the term “alkyl”, used either alone or in compound words such as “haloalkyl” or “fluoroalkyl” includes straight-chain or branched alkyl, such as, methyl, ethyl, n-propyl, i-propyl, or the different butyl isomers. “Alkoxy” includes, for example, methoxy, ethoxy, n-propyloxy, isopropyloxy and the different butoxy isomers. The term “halogen”, either alone or in compound words such as “haloalkyl”, includes fluorine, chlorine, bromine or iodine. Further, when used in compound words such as “haloalkyl” or “haloalkoxy”, said alkyl may be partially or fully substituted with halogen atoms which may be the same or different. Examples of “haloalkyl” include CF₃, CH₂Cl, CH₂CF₃ and CCl₂CF₃. The terms “haloalkoxy”, and the like, are defined analogously to the term “haloalkyl”. Examples of “haloalkoxy” include OCF₃, OCH₂CCl₃, OCH₂CH₂CHF₂ and OCH₂CF₃.

The total number of carbon atoms in a substituent group is indicated by the “Cᵢ-Cⱼ” prefix where i and j are numbers from 1 to 4. For example, C₁-C₄ alkyl designates methyl through butyl, including the various isomers.

Carboxamide arthropodicides (e.g., Formulae 1 or 2) for the method of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. These carboxamide arthropodicides may be present as a mixture of stereoisomers, individual stereoisomers, or as an optically active form.

The carboxamide arthropodicides (e.g., Formula 1) for the present method can also be in the form of N-oxides. One skilled in the art will appreciate that not all nitrogen containing heterocycles can form N-oxides since the nitrogen requires an available lone pair for oxidation to the oxide; one skilled in the art will recognize those nitrogen containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The carboxamide arthropodicides (e.g., Formulae 1 or 2) for the present method can also be in the form of salts. Such salts include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Salts can also include those formed with organic bases (e.g., pyridine or triethylamine) or inorganic bases (e.g., hydrides, hydroxides, or carbonates of sodium, potassium, lithium, calcium, magnesium or barium) when the carboxamide arthropodicide contains an acidic group such as a carboxylic acid or phenol.

### Formulation/Utility

The carboxamide arthropodicides according to the methods of this invention can generally be used as a formulation or a composition with a carrier suitable for agronomic or nonagronomic uses comprising at least one component selected from the group consisting of a solid diluent, a liquid diluent and a surfactant. Suitable formulations are disclosed in U.S. Pat. No. 6,747,047, PCT Publications WO 2003/015518, WO 2004/067528 and U.S. Pat. No. 6,603,044.

The formulations will typically contain effective amounts of active ingredient, diluent and surfactant within the following approximate ranges which add up to 100 percent by weight. Said formulated composition can then be diluted with water to the desired sub-lethal, reproduction-disruptive application rates. Examples of suitable compositions comprising a sub-lethal, reproduction-disruptive amount of a carboxamide arthropodicide include liquid compositions comprising water, organic solvent, or oil as a liquid diluent.

| | Weight Percent | | |
|---|---|---|---|
| | Active | | |
| | Ingredient | Diluent | Surfactant |
| Water-Dispersible and Water- | 0.001-90 | 0.001-99.999 | 0-15 |
| soluble Granules, Tablets | | | |
| and Powders. | | | |
| Suspensions, Emulsions, | 1-50 | 40-99 | 0-50 |
| Solutions (including | | | |
| Emulsifiable | | | |
| Concentrates) | | | |
| Dusts | 1-25 | 70-99 | 0-5 |
| Granules and Pellets | 0.001-99 | 5-99.999 | 0-15 |
| High Strength Compositions | 90-99 | 0.001-10 | 0-2 |

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the method of this invention the carboxamide arthropodicide is typically contacted with adult arthropod pest or its environment in the form of a composition comprising in addition to the carboxamide arthropodicide at least one additional component selected from the group consisting of a surfactant and a liquid diluent. Thus the present invention also pertains to a method wherein a composition comprising a sub-lethal, reproduction-disruptive amount of a carboxamide arthropodicide and at least one additional component selected from the group consisting of surfactants and liquid diluents in contacted with the adult arthropod pest or its environment.

Methods of this invention can be applied to plants genetically transformed to express proteins toxic to invertebrate pests (such as Bacillus thuringiensis delta-endotoxins). The effect of the exogenously applied sub-lethal, reproduction-disruptive amount of a carboxamide arthropodicide may be synergistic with the expressed toxin proteins in disrupting reproduction.

In certain instances, combinations with other arthropodicides having a similar spectrum of control but a different mode of action will be particularly advantageous for resistance management. General references for other arthropodicides include The Pesticide Manual, 13^{th} Edition, C. D. S. Tomlin, Ed., British Crop Protection Council, Farnham, Surrey, U.K., 2003 and The BioPesticide Manual, 2^{nd} Edition, L. G. Copping, Ed., British Crop Protection Council, Farnham, Surrey, U.K., 2001.

Reproduction of arthropod pests is disrupted in agronomic and nonagronomic applications by applying a composition comprising a carboxamide arthropodicide in a sub-lethal, reproduction-disruptive amount to the environment of the pests, including the agronomic and/or nonagronomic locus of infestation, to the area to be protected, or directly on the pests to be controlled. Agronomic applications include protecting a field crop from arthropod pest reproduction typically by applying a composition comprising a carboxamide arthropodicide in a sub-lethal, reproduction-disruptive amount to the seed of the crop before planting, to the foliage, stems, flowers and/or fruit of crop plants, or to the soil or other growth medium before or after the crop is planted. Nonagronomic applications relate to disruption of arthropod pests in areas other than fields of crop plants. Nonagronomic applications include disruption of arthropod pest reproduction in stored grains, beans and other foodstuffs, and in textiles such as clothing and carpets. Nonagronomic applications also include disruption of arthropod pest reproduction in ornamental plants, forests, orchards, in yards, along roadsides and railroad rights of way, and on turf such as lawns, golf courses and pastures. Nonagronomic applications also include disruption of arthropod pest reproduction in houses and other buildings which may be occupied by humans and/or companion, farm, ranch, zoo or other animals. Nonagronomic applications also include disruption of reproduction of pests such as termites that can damage wood or other structural materials used in buildings. Nonagronomic applications also include protecting human and animal health by disruption of reproduction of pests that are parasitic or transmit infectious diseases. Such pests include, for example, chiggers, ticks, lice, mosquitoes, flies and fleas.

Reproduction of arthropod pests is disrupted and protection of agronomic and other crops, and animal and human health is achieved by applying a composition comprising a carboxamide arthropodicide in a sub-lethal, reproduction-disruptive amount to the environment of the adult pests including the agronomic and/or nonagronomic locus of infestation, to the area to be protected, or directly on the adult pests. Therefore, the present invention comprises a method for disrupting the reproduction of an adult arthropod pest in agronomic and/or nonagronomic applications, comprising contacting the adult arthropod pest or its environment with a sub-lethal, reproduction-disruptive amount of a carboxamide arthropodicide, or with a composition comprising a sub-lethal, reproduction-disruptive amount of a carboxamide arthropodicide. More particularly, the present invention comprises a method for the disruption of reproduction of foliar and soil-inhabiting arthropods and protection of agronomic and/or nonagronomic crops, comprising applying a composition comprising a carboxamide arthropodicide in a sub-lethal, reproduction-disruptive amount to the environment of the pests including the agronomic and/or nonagronomic locus of infestation, to the area to be protected, or directly on the adult pests.

One embodiment of a method of contact is by spraying the pest and/or the environment of the pest. Alternatively, according to the method of the present invention, the carboxamide arthropodicide can be effectively delivered through plant uptake by contacting the plant with a composition comprising a sub-lethal, reproduction-disruptive amount of a carboxamide arthropodicide applied as a soil drench of a liquid formulation.

Of note is a method for controlling an arthropod pest comprising contacting the soil environment of the arthropod pest with a sub-lethal, reproduction-disruptive amount of a carboxamide arthropodicide. Of further note is the method of this invention comprising topical application to the locus of infestation. Other methods of contact include application of a carboxamide arthropodicide according to the methods of the invention by direct and residual sprays, aerial sprays, gels, seed coatings, microencapsulations, systemic uptake, baits, ear tags, boluses, foggers, fumigants, aerosols, dusts and many others. The carboxamide arthropodicide according to the methods of this invention can also be impregnated into materials for fabricating arthropod control devices (e.g., insect netting). Seed coatings can be applied to all types of seeds, including those from which plants genetically transformed to express specialized traits will germinate. Representative examples include those expressing proteins toxic to invertebrate pests, such as Bacillus thuringiensis toxin or those expressing herbicide resistance, such as “Roundup Ready” seed.

The carboxamide arthropodicide according to the method of this invention can be applied at rates equal or below LC₅₀ without other adjuvants, but most often application will be of a formulation comprising the carboxamide arthropodicide in combination with suitable carriers, diluents, and surfactants and possibly in combination with a food depending on the contemplated end use. One method of application involves spraying an aqueous dispersion or refined oil solution of a carboxamide arthropodicide. Combinations with spray oils, spray oil concentrations, spreader stickers, adjuvants, other solvents, and synergists such as piperonyl butoxide often enhance efficacy. For nonagronomic uses such sprays can be applied from spray containers such as a can, a bottle or other container, either by means of a pump or by releasing it from a pressurized container, e.g., a pressurized aerosol spray can. Such spray compositions can take various forms, for example, sprays, mists, foams, fumes or fog. Such spray compositions thus can further comprise propellants, foaming agents, etc. as the case may be. Of note is a spray composition comprising a sub-lethal, reproduction-disruptive amount of a carboxamide arthropodicide or a composition comprising a sub-lethal, reproduction-disruptive amount of a carboxamide arthropodicide of the present invention and a carrier. One embodiment of such a spray composition comprises a sub-lethal, reproduction-disruptive amount of a carboxamide arthropodicide or a composition comprising a sub-lethal, reproduction-disruptive amount of a carboxamide arthropodicide of the present invention and a propellant. Representative propellants include, but are not limited to, methane, ethane, propane, butane, isobutane, butene, pentane, isopentane, neopentane, pentene, hydrofluorocarbons, chlorofluorocarbons, dimethyl ether, and mixtures of the foregoing. Of note is a spray composition (and a method utilizing such a spray composition dispensed from a spray container) used to control at least one arthropod pest selected from the group consisting of mosquitoes, black flies, stable flies, deer flies, horse flies, wasps, yellow jackets, hornets, ticks, spiders, ants, gnats, and the like, including individually or in combinations.

The carboxamide arthropodicide according to the method of the present invention can be incorporated into a bait composition that is consumed by an arthropod pest or used within a device such as a trap, bait station, and the like. Such a bait composition can be in the form of granules which comprise (a) active ingredients, namely a sub-lethal, reproduction-disruptive amount of a carboxamide arthropodicide; (b) one or more food materials; optionally (c) an attractant, and optionally (d) one or more humectants. Of note are granules or bait compositions which comprise between about 0.001-0.1% active ingredients, about 40-99% food material and/or attractant; and optionally about 0.05-10% humectants, which are effective in controlling soil invertebrate pests at very low application rates, particularly at doses of active ingredient that are sub-lethal, reproduction-disruptive by ingestion. Some food materials can function both as a food source and an attractant. Food materials include carbohydrates, proteins and lipids. Examples of food materials are vegetable flour, sugar, starches, animal fat, vegetable oil, yeast extracts and milk solids. Examples of attractants are odorants and flavorants, such as fruit or plant extracts, perfume, or other animal or plant component, pheromones or other agents known to attract a target arthropod pest. Examples of humectants, i.e. moisture retaining agents, are glycols and other polyols, glycerine and sorbitol. Of note is a bait composition (and a method utilizing such a bait composition) used to disrupt reproduction at least one adult arthropod pest selected from the group consisting of ants, termites and cockroaches. A device for disrupting reproduction of an arthropod pest can comprise the present bait composition and a housing adapted to receive the bait composition, wherein the housing has at least one opening sized to permit the invertebrate pest to pass through the opening so the arthropod pest can gain access to the bait composition from a location outside the housing, and wherein the housing is further adapted to be placed in or near a locus of potential or known activity for the arthropod pest.

The rate of application (e.g., concentration) of a carboxamide arthropodicide required for effectively disrupting reproduction of an adult arthropod pest while causing no more than about 50% mortality of the adult pest population will depend on such factors as the pest species, its size, location, season, host crop or animal, feeding behavior, ambient moisture, temperature, method of application, and the like. Under normal circumstances, the LC₈₀, LC₅₀ or LC₂₀ (concentration causing 80, 50 or 20% mortality) of a carboxamide arthropodicide is first determined for a particular pest species using the selected application conditions. Although concentrations less than the LC₂₀ can in some circumstances significantly disrupt reproductive performance, more typically concentrations in range of the LC₂₀ to LC₅₀ are used. If concentrations at the lower end of this range are found not to provide the desired level of reproduction disruption, concentrations closer or equal to the LC₅₀ can be used. The range of concentrations between LC₂₀ to LC₅₀ is relatively small, and one skilled in the art can easily determine the sub-lethal amount providing the desired level of arthropod pest control through disruption of reproductive performance.

Application rates of sub-lethal, reproduction-disruptive amounts of carboxamide arthropodicides are typically found to be within the range from about 1 to about 250 g per hectare for agronomic ecosystems, but as little as 0.1 g/hectare may be needed or as much as 500 g/hectare may be required. For nonagronomic applications, use rates of sub-lethal, reproduction-disruptive amounts of carboxamide arthropodicides are typically found to be within the range from about 1 to about 50 mg/square meter, but as little as 0.1 m/square meter may be sufficient or as much as 150 mg/square meter may be required.

Pests are effectively controlled by the methods of the present invention include adults of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), corn stalk borer (Sesamia nonagrioides Lefebvre), southern armyworm (Spodoptera eridania Cramer), tobacco cutworm, cluster caterpillar (Spodoptera litura Fabricius), cotton leafworm (Spodoptera littoralis Boisduval), yellowstriped armyworm (Spodoptera ornithogalli Guenée), black cutworm (Agrotis ipsilon Hufnagel), cabbage looper (Trichoplusia ni Hübner), tobacco budworm (Heliothis virescens Fabricius), spiny bollworm (Earias insulana Boisduval), spotted bollworm (Earias vittella Fabricius), cotton bollworm (Helicoverpa armigera Hübner), corn earworm (Helicoverpa zea Boddie), cotton leafworm (Alabama argillacea Hübner), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), pink stem borer (Sesamia inferens Walker)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworms (Pyralidae: Crambinae) such as sod worm (Herpetogramma licarsisalis Walker), sugarcane stem borer (Chilo infuscatellus Snellen), tomato small borer (Neoleucinodes elegantalis Guenée), green leafroller (Cnaphalocerus medinalis), grape leaffolder (Desmia funeralis Hübner), melon worm (Diaphania nitidalis Stoll), cabbage center grub (Helluala hydralis Guenée), yellow stem borer (Scirpophaga incertulas Walker), early shoot borer (Scirpophaga infuscatellus Snellen), white stem borer (Scirpophaga innotata Walker), top shoot borer (Scirpophaga nivella Fabricius), dark-headed rice borer (Chilo polychrysus Meyrick), cabbage cluster caterpillar (Crocidolomia binotalis English), rice stem borer (Chilo suppressalis Walker), spotted stalk borer (Chilo partellus Swinhoe), sugarcane borer (Eldana saccharina Walker), and bluegrass webworm (Crambus teterrellus Zincken)); leafrollers, budworms, seed worms, and fruit worms in the family Tortricidae (e.g., grape berry moth (Endopiza viteana Clemens), vine moth or grape moth (Lobesia botrana Denis & Schiffermüller), fruit tree leaf roller (Archips argyrospila Walker), European leaf roller (Archips rosana Linnaeus) and other Archips species, citrus false codling moth (Cryptophlebia leucotreta Meyrick), citrus borer (Ecdytolopha aurantiana Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia ambiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); borers and worms and moths from the family Gelechiidae (e.g., tomato pinworm (Keiferia lycopersicella Walshingham), potato tuber moth (Phthorimaea operculella Zeller), beet moth (Scrobipalpa ocellatella Boyd), tomato leafminer (Tuta absoluta Meyrick), peach twig borer (Anarsia lineatella Zeller) and pink bollworm (Pectinophora gossypiella Saunders)); and many other economically important lepidoptera pests (e.g., diamondback moth (Plutella xylostella Linnaeus) in the family Plutellidae, gypsy moth (Lymantria dispar Linnaeus), peach fruit borer (Carposina niponensis Walsingham), citrus leafminer (Phyllocnistis citrella Stainton), large white butterfly (Pieris brassicae Linnaeus), small white butterfly (Pieris rapae Linnaeus), spotted teniform leafminer (Lithocolletis blancardella Fabricius), Asiatic apple leafminer (Lithocolletis ringoniella Matsumura), rice leaffolder (Lerodea eufala Edwards), apple leafminer (Leucoptera scitella Zeller) and rice leaf roller (Cnaphalocrosis medinalis Guenee)); adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)), annual bluegrass weevil (Listronotus maculicollis Dietz), plum curculio (Conotrachelus nenuphar Herbst), alfalfa weevil (Hypera postica Gyllenhal), beet weevil (Bothynoderes punctiventris Germar), bluegrass billbug (Sphenophorus parvulus Gyllenhal), hunting billbug (Sphenophorus venatus vestitus), Denver billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera virgifera LeConte), southern corn leaf beetle (Myochrous denticollis Say), Mexican bean beetle (Epilachna varivestis Mulsant), bean leaf beetle (Cerotoma trifurcata Först.), cereal leaf beetle (Oulema melanopus Linnaeus), rootworms of the genera Diabrotica and flea beetles of the genera Psylliodes or Phyllotreta); chafers and other beetles from the family Scaribaeidae (e.g., Japanese beetle (Popillia japonica Newman), oriental beetle (Anomala orientalis Waterhouse), northern masked chafer (Cyclocephala borealis Arrow), southern masked chafer (Cyclocephala immaculata Olivier or C. lurida Bland), dung beetle and white grub (Aphodius spp.), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae such as wireworms of the genera Agriotes, Athous or Limonius; bark beetles from the family Scolytidae and flour beetles from the family Tenebrionidae. In addition, agronomic and nonagronomic pests include: adults of the order Dermaptera including earwigs from the family Forficulidae (e.g., European earwig (Forficula auricularia Linnaeus), black earwig (Chelisoches morio Fabricius)); adults of the orders Hemiptera and Homoptera such as, plant bugs from the family Miridae, cicadas from the family Cicadidae such as periodical cicada (Magicidada septendecim Linnaeus); leafhoppers (e.g. Empoasca spp.) from the family Cicadellidae (e.g., potato leafhopper (Empoasca fabae Harris), aster leafhopper (Macrolestes quadrilineatus Forbes), green leafhopper (Nephotettix cinticeps Uhler), rice leafhopper (Nephotettix nigropictus Stål), rice green leafhopper (Nephotettix virescens Distant), white apple leafhopper (Typhlocyba pomaria McAtee) and grape leafhoppers (Erythroneura spp.)); bed bugs (e.g., Cimex lectularius Linnaeus) from the family Cimicidae; planthoppers from the families Fulgoroidae and Delphacidae (e.g., smaller brown planthopper (Laodelphax striatellus Fallen), brown planthopper (Nilaparvata lugens Stål), corn planthopper (Peregrinus maidis Ashmead), white-backed planthopper (Sogatella furcifera Horvath) and rice delphacid (Sogatodes oryzicola Muir)); treehoppers from the family Membracidae, psyllids from the family Psyllidae (e.g., pear psylla (Cacopsylla pyricola Foerster), Asian citrus psyllid (Diaphorina citri Kuwayama), potato psyllid (Paratrioza cockerelli Sulc), persimmon psylla (Trioza diospyri Ashmead) and hackberry nipplegall maker (Pachypsylla celtidismamma Fletcher)); whiteflies from the family Aleyrodidae (e.g., tobacco whitefly, sweetpotato whitefly (Bemisia tabaci Gennadius), silverleaf whitefly (Bemisia argentifolii Bellows & Perring), citrus whitefly (Dialeurodes citri Ashmead) and greenhouse whitefly (Trialeurodes vaporariorum Westwood)); aphids from the family Aphididae (e.g., pea aphid (Acyrthisiphon pisum Harris), cowpea aphid (Aphis craccivora Koch), black bean aphid (Aphis fabae Scopoli), cotton aphid, melon aphid (Aphis gossypii Glover), apple aphid (Aphis pomi De Geer), spirea aphid (Aphis spiraecola Patch), foxglove aphid (Aulacorthum solani Kaltenbach), strawberry aphid (Chaetosiphon fragaefolii Cockerell), Russian wheat aphid (Diuraphis noxia Kurdjumov/Mordvilko), rosy apple aphid (Dysaphis plantaginea Paaserini), woolly apple aphid (Eriosoma lanigerum Hausmann), mealy plum aphid (Hyalopterus pruni Geoffroy), turnip aphid (Lipaphis erysimi Kaltenbach), cereal aphid (Metopolophium dirrhodum Walker), potato aphid (Macrosipum euphorbiae Thomas), peach-potato aphid, green peach aphid (Myzus persicae Sulzer), lettuce aphid (Nasonovia ribisnigri Mosley), root aphids and gall aphids (Pemphigus spp.), corn leaf aphid (Rhopalosiphum maidis Fitch), bird cherry-oat aphid (Rhopalosiphum padi Linnaeus), greenbug (Schizaphis graminum Rondani), English grain aphid (Sitobion avenae Fabricius), spotted alfalfa aphid (Therioaphis maculata Buckton), black citrus aphid (Toxoptera aurantii Boyer de Fonscolombe), brown citrus aphid (Toxoptera citricida Kirkaldy) and betelvine aphid (Aphis frangulae Kaltenbach)); phylloxera from the family Phylloxeridae such as pecan phylloxera (Phylloxera devastatrix Pergande); mealybugs from the family Pseudococcidae (e.g., citrus mealybug (Planococcus citri Risso), long-tailed mealybug (Pseudococcus longispinus Targioni-Tozzetti) and other mealybug complex (other Pseudococcus spp.); scales from the families Coccidae, Diaspididae and Margarodidae (e.g., brown soft scale (Coccus hesperidum Linnaeus), green scale (Coccus viridis Green), cottony cushion scale (Icerya purchasi Maskell) and San Jose scale (Quadraspidiotus perniciosus Comstock)); and spittlebugs from the family Cercopidae; seed bugs from the family Lygaeidae (e.g., hairy chinch bug (Blissus leucopterus leucopterus Say), southern chinch bug (Blissus insularis Barber), large milkweed bug (Oncopeltus fasciatus Dallas) and Rutherglen bug (Nysius vinitor Bergroth)); plant bugs from the family Miridae (e.g., tomato bug (Cyrtopeltis modesta Distant), tarnished plant bug (Lygus lineolaris Palisot de Beauvois) and cotton fleahopper (Pseudatomoscelis seriatus Reuter)); stink bugs from the family Pentatomidae (e.g., green stink bug (Acrosternum hilare Say), brown stink bug (Euchistus servus Say), southern green stink bug (Nezara viridula Linnaeus), rice stink bug (Oebalus pugnax Fabricius) and one-spotted stink bug (Euchistus variolarius Palisot de Beauvois)); squash bugs from the family Coreidae (e.g., squash bug (Anasa tristis De Geer) and leaf-footed pine seed bug (Leptoglossus corculus Say)); lace bugs from the family Tingidae such as cotton lace bug (Corythucha gossypii Fabricius); and red bugs and cotton stainers from the family Pyrrhocoridae such as cotton stainer (Dysdercus suturellus Herrich-Schäffer). Also included are adults of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)); flat mites in the family Tenuipalpidae (e.g., citrus flat mite (Brevipalpus lewisi McGregor)); rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae (e.g., deer tick (Ixodes scapularis Say), Australian paralysis tick (Ixodes holocyclus Neumann), American dog tick (Dermacentor variabilis Say), lone star tick (Amblyomma americanum Linnaeus)) and scab and itch mites in the families Psoroptidae, Pyemotidae, and Sarcoptidae; adults of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borellii Giglio-Tos)); adults of the order Diptera including leafminers, midges, fruit flies (Tephritidae), frit flies (e.g., Oscinella frit Linnaeus), soil maggots, houseflies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; adults of the order Thysanoptera including onion thrips (Thrips tabaci Lindeman), melon thrips (Thrips palmi Karny), western flower thrips (Frankliniella occidentalis Pergande), bean blossom thrips (Megalurothrips usitatus Bagnall), citrus thrip (Scirthothrips citri Moulton), soybean thrips (Sericothrips variabilis Beach), oriental rice thrips (Stenchaetothrips biformis Bagnall), and other foliar feeding thrips; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster), odorous house ant (Tapinoma sessile Say), bees (including carpenter bees), hornets, yellow jackets, wasps, and sawflies (Neodiprion spp.; Cephus spp.); insect pests of the Family Formicidae including the Florida carpenter ant (Camponotus floridanus Buckley), red carpenter ant (Camponotus ferrugineus Fabricius), black carpenter ant (Camponotus pennsylvanicus De Geer), white-footed ant (Technomyrmex albipes fr. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster) and odorous house ant (Tapinoma sessile Say). Other Hymenoptera including bees (including carpenter bees), hornets, yellow jackets, wasps, and sawflies (Neodiprion spp.; Cephus spp.); insect pests of the order Isoptera including termites in the Termitidae (e.g., Macrotermes sp., Odontotermes obesus Rambur), Kalotermitidae (e.g., Cryptotermes sp.), and Rhinotermitidae (e.g., Reticulitermes sp., Coptotermes sp., Heterotermes tenuis Hagen) families, the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus). Those skilled in the art will appreciate that not all pests can be equally effective controlled by the methods of the present invention.

Of note is the method of this invention for controlling housefly (Musca domestica). Of note is the method of this invention for controlling green peach aphid (Myzus persicae). Of note is the method of this invention for controlling rice green leafhopper (Nephotettix virescens). Of note is the method of this invention for controlling western flower thrip (Frankliniella occidentalis). Of note is the method of this invention for controlling Colorado potato beetle (Leptinotarsa decemlineata). Of note is the method of this invention for controlling beet armyworm (Spodoptera exigua). Of note is the method of this invention for controlling diamondback moth (Plutella xylostella). Of note is the method of this invention for controlling cotton bollworm (Helicoverpa armigera). Of note is the method of this invention for controlling silverleaf whitefly (Bemisia argentifolii).

The following TESTS demonstrate the disrupting reproductive performance effects on specific pests (including fertility and/or fecundity) using the method of this invention. The reproductive performance disruption afforded by the methods is not limited, however, to these species.

COMPOUND TABLE 1

| Compound No. | |
|---|---|
| 1 | 3-bromo-N-[4-chloro-2-methyl-6-[(methylamino)carbonyl]phenyl]- |
| | 1-(3-chloro-2-pyridinyl)-1H-pyrazole-5-carboxamide. |
| 2 | 3-bromo-1-(3-chloro-2-pyridinyl)-N-[4-cyano-2-methyl-6-[(methylamino)- |
| | carbonyl]phenyl]-1H-pyrazole-5-carboxamide. |
| 3 | N²-[1,1-dimethyl-2-(methylsulfonyl)ethyl]-3-iodo-N¹-[2-methyl-4- |
| | [1,2,2,2-tetrafluoro-1-(trifluoromethyl)ethyl]phenyl]- |
| | 1,2-benzenedicarboxamide. |
| 4 | N-[4-chloro-2-methyl-6-[[(1-methylethyl)amino]carbonyl]phenyl]- |
| | 1-(3-chloro-2-pyridinyl)-3-(trifluoromethyl)-1H-pyrazole-5-carboxamide. |
| 5 | N-[4-chloro-2-methyl-6-[(methylamino)carbonyl]phenyl]-1-(3-chloro- |
| | 2-pyridinyl)-3-(trifluoromethyl)-1H-pyrazole-5-carboxamide. |
| 6 | 3-bromo-N-[4-chloro-2-methyl-6-[[(1-methylethyl)amino]carbonyl]- |
| | phenyl]-1-(3-chloro-2-pyridinyl)-1H-pyrazole-5-carboxamide. |
| 7 | 1-(3-chloro-2-pyridinyl)-N-[4-cyano-2-methyl-6-[(methylamino)carbonyl]- |
| | phenyl]-3-(trifluoromethyl)-1H-pyrazole-5-carboxamide. |
| 8 | 3-bromo-1-(2-chlorophenyl)-N-[4-cyano-2-methyl-6-[[(1-methylethyl)- |
| | amino]carbonyl]phenyl]-1H-pyrazole-5-carboxamide. |
| 9 | 3-bromo-1-(2-chlorophenyl)-N-[4-cyano-2-methyl-6-[(methylamino)- |
| | carbonyl]phenyl]-1H-pyrazole-5-carboxamide. |
| 10 | 3-bromo-1-(2-chlorophenyl)-N-[2,4-dichloro-6-[(methylamino)carbonyl]- |
| | phenyl]-1H-pyrazole-5-carboxamide. |
| 11 | 3-bromo-N-[4-chloro-2-[[(cyclopropylmethyl)amino]carbonyl]-6-methyl- |
| | phenyl]-1-(3-chloro-2-pyridinyl)-1H-pyrazole-5-carboxamide. |
| 12 | 3-bromo-1-(3-chloro-2-pyridinyl)-N-[4-cyano-2-[[(cyclopropylmethyl)- |
| | amino]carbonyl]-6-methylphenyl]-1H-pyrazole-5-carboxamide. |
| 13 | 3-bromo-N-[4-chloro-2-[[(1-cyclopropylethyl)amino]carbonyl]-6-methyl- |
| | phenyl]-1-(3-chloro-2-pyridinyl)-1H-pyrazole-5-carboxamide. |
| 14 | 3-bromo-1-(3-chloro-2-pyridinyl)-N-[4-cyano-2-[[(1-cyclopropylethyl)- |
| | amino]carbonyl]-6-methylphenyl]-1H-pyrazole-5-carboxamide. |
| 15 | N²-[1,1-dimethyl-2-(methylsulfonyl)ethyl]-3-iodo-N¹-[2-methyl-4- |
| | [1,2,2,2-tetrafluoro-1-(trifluoromethyl)ethyl]phenyl]- |
| | 1,2-benzenedicarboxamide. |

Methods for preparing the compounds listed in Compound Table 1 are disclosed in U.S. Pat. No. 6,747,047, PCT Publications WO 2003/015518, WO 2004/067528 and U.S. Pat. No. 6,603,044.

### BIOLOGICAL EXAMPLES OF THE INVENTION

### General Procedure for Determining the “Sub-Lethal Dose or Concentration”

The sub-lethal concentrations or doses used in the various tests for the specific pest species and populations tested in the context of the present invention were estimated from multiple-rate, dose-finding tests to determine the control rates and activity break rates. Test compounds at concentrations resulting in 80% or greater mortality (i.e. ≧LC₈₀) were adjudged to show economic level control, whereas the sub-lethal concentrations were selected where compound performance resulted in 50% or less mortality (i.e. ≦LC₅₀). Therefore, depending on the target pest species, either the LC₅₀ or a suitable concentration between LC₅₀ and LC₂₀ was selected as the sub-lethal dose. The specific procedures used to select the respective doses are described in each Test.

### Test A

For evaluating housefly, Musca domestica (L.), each test unit consisted of a pair of virgin adult female and male houseflies of similar age (±1 day). To obtain the adult flies used in the study, pupae of approximately the same age (±1 day) were separated by sex, and placed in separate containers until adults emerged.

The LC₂₀ sub-lethal dose of Compound 2 on the housefly was estimated to be 2 ppm using probit analysis extrapolation based on the preliminary dose-response curves obtained at concentrations of 50, 100, 500 and 1000 ppm. Two treatments consisted of Compound 2 at 2 ppm and a control without test compound. Each treatment had 10 replicates.

After emergence, the adult houseflies were placed in a meshed cage and were sprayed with test solutions using a belt sprayer. Test solutions were applied using a compressed air-propelled (moving) belt sprayer equipped with an 8001E Tee Jet flat fan spray nozzle. The nozzles were positioned at about 20 cm above the test unit, and calibrated at 276 kPa to deliver volumes equivalent to 500 L/ha. The treated houseflies were then transferred individually to a clean container made from a clear plastic cup covered with cloth and containing a plug of cotton wick soaked in 10% sucrose solution as a diet source.

One day after treatment, a treated male and a treated female were placed together and allow to copulate in a cage made from a 300 mL clear plastic cup covered with screened cloth and containing a source of adult diet and a substrate for ovipositioning. The substrate consisted of a cotton wick plug previously soaked in 5% ammonium carbonate solution.

Observations of the number of eggs laid per adult female were made daily for 7 days. The cotton wicks containing eggs were removed daily and counted, and then kept in a growth chamber at 26° C., 75% relative humidity and 16 hours of light per day to allow egg hatching and emergence of neonates. To measure effects on fertility, the number of neonates produced per female was totaled on the 8th day after treatment.

The results are listed in Table A. The data indicated that Compound 2 at 2 ppm adversely affected the fecundity (as represented by the mean number of eggs per female) of the houseflies.

TABLE A
Effect on the reproductive performance of adult houseflies upon
treatment with test compound at sub-lethal concentration.

| | | Mean number of eggs | Mean number of |
|---|---|---|---|
| Treatment | Rate | per female | neonates per female |
| Control | — | 93.1 | 18.8 |
| Compound 2 | 2 ppm | 63.9 | 16.7 |

### Test B

For evaluating reproductive performance effects on green peach aphid (Myzus persicae Sulzer), each test unit consisted of a radish plant grown in a 6 cm×6 cm square pot infested with a mixed population (nymphs and adults) of green peach aphids from a laboratory-reared culture. Each plant was infested with about 100 aphids. Test solutions were prepared and sprayed on the test plants (2 plants per treatment) as described for TEST A. Treatments included Compound 1 at 100 and 500 ppm, Compound 2 at 4 and 6 ppm, and a control without test compound.

Aphids were kept on the treated plants for 24 hours, and then only adult aphids staying on the treated plant were transferred to untreated radish plants grown singly in a 6 cm×6 cm square pots. One test unit or one replicate consisted of a single adult aphid on a radish plant in a pot. The number of nymphs in each replicate was counted 4 and 6 days after treatment. At the higher concentration of each test compound a total of 45 replicates were used, and at the lower concentration of each test compound a total of 30 replicates were used. In addition, prior to transferring aphids singly to the untreated radish plants one day after treatment (1 DAT), the total number of aphids living and those remaining on the treated plant were counted.

The results are listed in Table B. Square-root transformation was done on the number of nymphs produced per adult (female) aphid, and the data were analyzed using analysis of variance (ANOVA) and Fisher's Least Significant Difference (LSD) tests for separation of means. For each evaluation period, means in each column with the same letter are not significantly different (Fisher's LSD test, P=0.05).

According to the data shown in Table B, one day after treatment (just prior to the transfer) the number of living aphids was above 80% for all treatments; however, plants treated with Compound 2 had 28-48% of living aphids that did not stay on the plant. Many of these aphids were moribund. Compared with the untreated control, treatment of Compound 2 at 6 ppm resulted in significantly fewer nymphs per transferred adult at both 4 and 6 days after treatment, and treatment with 4 ppm of Compound 2 resulted in significantly fewer nymphs at 4 days after treatment (Table B). The data indicated that using the method of exposure and concentrations tested, treatment of sub-lethal concentrations of Compound 2 reduced the fecundity of green peach aphid.

TABLE B
Number of nymphs produced by green peach aphid after 24 hours exposure to
various treatments.

| | | 1 DAT | | 4 DAT | | 6 DAT | |
|---|---|---|---|---|---|---|---|
| | | | On | No. of | | No. of | |
| | | Living | plant | nymphs* | No. | nymphs* | No. |
| Treatment | ppm | (%)¹ | (%)² | (mean ± SE) | replicates³ | (mean ± SE) | replicates³ |
| Control | 0 | 99.7 | 99.7 | 3.8 ± 0.4 ab | 29 | 6.8 ± 0.5 a | 26 |
| Compound 1 | 100 | 99.9 | 99.6 | 3.5 ± 0.3 b | 29 | 7.3 ± 0.4 a | 29 |
| Compound 1 | 500 | 99.6 | 99.9 | 4.6 ± 0.3 a | 39 | 8.1 ± 0.5 a | 38 |
| Compound 2 | 4 | 97.6 | 72.0 | 2.3 ± 0.4 c | 15 | 6.1 ± 0.6 a | 14 |
| Compound 2 | 6 | 82.3 | 51.1 | 2.1 ± 0.7 c | 14 | 3.6 ± 0.8 b | 12 |

¹The percent of all aphids that were alive 24 h after the treatment of test compounds, just prior to the transfer of aphids to test units containing untreated radish plants.
²Percent of all aphids that were on the treated plant. Excluded from this category are aphids that were on the soil.
³Number of usable replicates - excludes replicates containing a dead adult from data analyses and calculations. TEST B: one-way ANOVA test (4 DAT: F = 6.07; df = 5, 141; P < 0.0001) (6 DAT: F = 7.7; df = 5, 134; P < 0.0001).
*Number of nymphs transferred per adult is reported with mean ± standard errors; a letter was assigned to the mean number according to the Fisher's Least Significant Difference (LSD) tests. Numbers with the same letter are not significantly different (Fisher's LSD test, P = 0.05).

### Test C

For evaluating the reproductive performance effects on rice green leafhopper (Nephotettix virescens Distant), each test unit consists of a 1-week-old rice seedling in a container and a newly emerged adult green leafhopper. A minimum of 160 adult female insects and 160 adult male insects are used.

Each batch of 40 newly emerged adults of same sex is placed inside a meshed cage. Caged adults are then subjected to treatments with test compounds at selected sub-lethal concentrations using a CO₂ backpack sprayer. The treated insects are then transferred to an untreated container containing a 40-day old rice plants. Two days after treatment, the number of live adult insects is recorded, and one treated male and one treated female insect are placed together in a copulation cage containing a 1-week-old rice seedling.

Each treatment has ten to twenty replicates, where a replicate consists a pair of adult virgin insects. Each pair of insects is moved daily to a new cup containing a fresh one-week old rice seedling. Daily evaluations are performed up to 14 or 21 days. The evaluation period is the period where the female adult green leafhoppers actively produce viable eggs. The eggs are placed in cage containing a one week-old rice seedlings for the fertility effect evaluation.

Recorded daily are data including: (i) number of live adult insects, (ii) number of eggs produced per adult female insect, (iii) number of eggs hatched per female, and (iv) number of nymphs that survived to the 2nd instar stage.

The data indicate that using the method of exposure and concentrations of test compound, treatment with sub-lethal concentrations of test compound reduces the fecundity and fertility of rice green leafhopper.

### Test D

For evaluating the reproductive performance effects on western flower thrips, (Frankliniella occidentalis Pergande), each test unit comprised a bean plant in a small pot with cylindrical plastic cover.

Previous study with Compound 2 on adult thrips showed that application rates of 10 ppm resulted in less than 50% adult mortality. Thus, the sub-lethal concentration of Compound 2 was selected to be 10 ppm in the test treatments. Test solutions were prepared by diluting with water to the selected concentration. Treatments included Compound 2 at 10 ppm as well as a control without test compound.

The test plants were sprayed with the test solutions using a belt sprayer equipped with an 8001E nozzle, and calibrated to deliver sprays at 468 L/ha, at a spray pressure of 207 kPa and a belt speed of 0.74 m/sec. The spray nozzle was placed 19 cm above the top of each potted plant unit. After spraying, the plants were allowed to dry in a well-ventilated area for about two hours. Each test unit containing a treated plant was then infested with about twenty adult thrips. After 24 hours exposure to the treated plants, a group of five live adult thrips were transferred to a fresh test unit containing an untreated bean plant. The test units were stored for 48 hours in a growth chamber provided with 16 hours of light per 24-h day, 70% relative humidity, and 23° C. daytime and 25° C. nighttime temperature, to allow oviposition (egg laying). Each unit with 5 adult thrips was considered a replicate, and a total of 8 replicates per treatment were used.

After 48 hours, the adult thrips were removed from the plants. Four days after the adult thrips were removed, the number of nymphs per plant was counted. The results are listed in Table D. The data were analyzed using Fisher's LSD tests for means separation. The mean numbers followed by the different letter are significantly different (Fisher's LSD test, P=0.05). These results indicate that the test colonies of adult western flower thrips that were exposed to a concentration (10 ppm) of Compound 2 and survived, subsequently produced significantly fewer nymphal offspring versus the untreated population (Table D), thus indicating their reproductive performance was adversely affected.

TABLE D
Mean number of western flower thrips nymphs on beans that were
treated with test compounds versus untreated plants.

| Treatment | Mean number of nymphs/plant* | N^{a} |
|---|---|---|
| Control | 59 ± 13 a | 8 |
| Compound 2 (10 ppm) | 33 ± 13 b | 8 |

^{a}N means number of replicates.
*Number of nymphs per plant is reported with mean ± standard errors; a letter was assigned to the mean number according to the Fisher's Least Significant Difference (LSD) tests. Numbers with different letter are significantly different (Fisher's LSD test, P = 0.05).

### Test E

For evaluating the reproductive performance effects on Colorado potato beetle, (Leptinotarsa decemlineata Say), a colony of potato beetles was cultured in the laboratory on potato plants. The pupae were provided soil material to facilitate pupation. On emergence from the soil, the adult beetles were separated into different cages to avoid initial contact between the male and female beetles. Immediately afterwards, the sex of each adult beetle was determined, and each individual insect was placed in a Petri dish and fed with pieces of excised potato leaves, before being placed in a whole plant-containing test unit for treatment with a test compound solution. Each treatment consisted of twenty adult beetles of the same age (10 males and 10 females), and a pair consisting of a male and female was considered to be a replicate; thus there were 10 replicates per treatment.

Test solutions were prepared by diluting the test compound with acetone to provide the selected sub-lethal concentrations. Treatments included Compound 1 at 6.25 and 25 ppm as well as a control without test compound.

A 15 day-old potato plant with 2 to 3 leaves in a round peat pot was infested with 10 pairs of adult beetles, and the test solution was applied at a spray pressure of 310 kPa using a moving boom tunnel sprayer equipped with one Teejet nozzle, model 8003-EVS and calibrated at speed of 1 m/s and 345 kPa to deliver about 280 L/ha. A piece of filter paper was wrapped around the plant and covered the soil, and the spray nozzle was placed 40 cm above the top of potted plant unit so that the upper surface of the leaves was the only part of the plant contacted with the spray mixture.

After 24 h, one treated male and one treated female were transferred onto a covered container containing a potato plant to allow mating to occur. The test units were held in a growth chamber provided with 16 hours of light per day, 70% relative humidity and 20° C. Daily observations were made to record oviposition data. The eggs deposited by the females were collected daily and counted for 20 days. The collected eggs were then placed in a Petri dish lined with moistened paper filter to prevent dehydration, and maintained in an incubator at 20-24° C. with 16 hours of light per day, 70% relative humidity. The number of hatched eggs and the number of viable larvae that developed to the pupal stage were also recorded. The study was discontinued after the remaining unhatched eggs succumbed to fungal infections and high humidity.

The results are listed in Table E. The data for adult Colorado potato beetles treated with Compound 1 at 6.25 and 25 ppm were not significantly different from the control. Thus, treatment with these low sub-lethal amounts of Compound 1 did not have apparent effects on the fecundity and fertility of adult Colorado potato beetles. This indicates that to practice the present method using Compound 1 under the described conditions on Colorado potato beetles requires sub-lethal, reproduction-disruptive concentrations closer to the LC₅₀.

TABLE E
Effects of sub-lethal treatments on adult Colorado potato beetles

| | Rate | Total number | Mean number | Mean number |
|---|---|---|---|---|
| Compound | (ppm) | of eggs | of hatched eggs | of viable larvae |
| Control | — | 285 | 199 | 86 |
| Compound 1 | 6.25 | 271 | 188 | 95 |
| Compound 1 | 25 | 287 | 219 | 117 |

### Test F

For evaluating the reproductive performance effects on beet armyworm (Spodoptera exigua), each test unit consisted of one pair of adult (female and male) Spodoptera exigua moths. To obtain the adult moths, pupae of approximately the same age (±1 day) were sexed and placed in individual containers until adults emerged. After emergence, the test insects were placed in a meshed cage.

Sub-lethal concentrations of Compound 1 on beet armyworm were defined based on a preliminary study using rates of 12.5, 25, 50 and 100 ppm. Treatments consisted of test solutions containing Compound 1 at 12.5, 20 and 31 ppm which corresponded to the LC₂₀, LC₅₀, and LC₈₀ (as estimated from the dose-response curve) and a control without test compound.

The caged adults were sprayed with test solutions of the designated treatments using a compressed air-propelled (moving) belt sprayer calibrated at 0.7 m/sec (to deliver a flow rate was ca. 5.5 mL/sec), at 207 kPa, using nozzle 8001E Tee Jet flat fan spray nozzle positioned 18 cm above the test units. Each treatment had 12 replicates (i.e. 12 adult females and 12 adult males were used per treatment).

One day after treatment, a treated male and female (one each) were placed in a cage made from a 300 mL clear plastic cup covered with screened cloth and allowed to copulate. A cotton wick/plug soaked with 10% sucrose solution was supplied in each cage as a diet source.

The number of eggs laid and number of eggs hatched were counted at 3, 4, 5 and 6 days after treatment (DAT), which represented the typical period in which female moths actively produce viable eggs. The pair of moths was transferred to a new cage after each evaluation. To evaluate the number of egg hatched, the copulation cages containing eggs were saved and maintained in a growth chamber at 27° C., 50% relative humidity and 16 hours of light per day.

The results are listed in Tables F1 and F2. The raw data were analyzed using Fisher's LSD tests for means separation. The numbers of eggs followed by the same letter are not significantly different (Fisher's LSD test, P=0.05). The percent of reduction was derived by dividing the number of eggs from each treatment by the number of eggs from the control, subtracting the quotient from 1, and then multiplying by 100%. The results indicated significant reductions in number of eggs (fecundity) and number of neonates (fertility) of beet armyworm treated with Compound 1 at all the tested rates and at all the observation dates. Therefore, treatments of Compound 1 at sub-lethal, reproduction-disruptive concentrations significantly affected the fecundity (Table F1) and fertility (Table F2) of beet armyworm as compared to the control treatment.

TABLE F1
Number of eggs and percent of reduction of oviposition of treated beet armyworm
versus control.

| | 3 DAT | | 4 DAT | | 5 DAT | | 6 DAT | |
|---|---|---|---|---|---|---|---|---|
| | | % of | | % of | | % of | | % of |
| Compound, Rate | No. eggs* | reduction | No. eggs* | reduction | No. eggs* | reduction | No. eggs* | reduction |
| Control | 2280 a | — | 927 a | — | 1181 a | — | 824 a | — |
| Compound 1, 12.5 ppm | 782 b | 66 | 315 b | 66 | 256 b | 77 | 219 b | 73 |
| Compound 1, 20 ppm | 208 b | 91 | 134 bc | 91 | 132 b | 89 | 109 b | 87 |
| Compound 1, 31 ppm | 61 b | 97 | 29 c | 97 | 91 b | 92 | 108 b | 87 |

*Number of eggs is reported with a letter according to the Fisher's Least Significant Difference (LSD) tests. Numbers with the same letter are not significantly different (Fisher's LSD test, P = 0.05).

TABLE F2
Total number of neonates (from successful egg hatch) and percent of egg hatch.

| | 3 DAT | | 4 DAT | | 5 DAT | | 6 DAT | |
|---|---|---|---|---|---|---|---|---|
| | No. | % | No. | % | No. | % | No. | % |
| Compound, Rate | neonates* | hatched | neonates* | hatched | neonates* | hatched | neonates* | hatched |
| Control | 2140 a | 94 | 764 a | 82 | 667 a | 56 | 565 a | 69 |
| Compound 1, 12.5 ppm | 647 b | 83 | 257 b | 82 | 154 b | 60 | 90 b | 41 |
| Compound 1, 20 ppm | 65 b | 31 | 0 b | 0 | 0 b | 0 | 0 b | 0 |
| Compound 1, 31 ppm | 0 b | 0 | 0 b | 0 | 0 b | 0 | 0 b | 0 |

*Number of neonates is reported with a letter according to the Fisher's Least Significant Difference (LSD) tests. Numbers with the same letter are not significantly different (Fisher's LSD test, P = 0.05).

### Test G

For evaluating the reproductive performance effects on diamondback moth (Plutella xylostella), a minimum of 120 larvae of diamondback moth of each sex were used. Male and female individuals of late instar larvae were separated and caged in individual containers containing Chinese kale. Male diamondback moths were identified by a white dot on the abdomen at the late instar larval stage. When pupae emerged, each pupa was caged separately until it emerged as adult.

Previous laboratory studies indicated that both Compounds 1 and 2 at 10 ppm resulted in about 20% mortality of the diamondback moth (LC₂₀); therefore 10 ppm was selected to be the sub-lethal concentration for both Compounds 1 and 2 in this test. In addition, a control without test compound was included.

Groups of 40 newly emerged (<24 hours) moths of the same sex were placed inside a meshed cage. The caged adult moths were then sprayed with the test solution, using a CO₂ backpack sprayer at 500 L/Ha. For the control treatment, the adults were sprayed with water at a similar spray volume. The groups of treated individuals were then transferred into a clean container with a source of adult diet (i.e. a cotton wick soaked in 10% sucrose solution). Separate containers were used for different groups of treated insects. One day after treatment, the numbers of live, moribund and dead adults were counted. One live treated male and one live treated female were placed together in a copulation cage, which was a 300 mL clear plastic cup covered with nylon screen supplied with an adult diet source of 10% sucrose solution.

Each pair of virgin adults was a replicate, and each treatment consisted of 10 to 20 replicates. Every day each pair of moths was moved to a new cup supplied with a diet of 10% sucrose solution.

The number of eggs laid per female moth was counted daily during the two days when the female moths actively produced viable eggs. The results, listed in Table G, indicate that no meaningful comparative information can be inferred, as the even the Control provided very few eggs per female moth; this indicates a systemic reproduction problem from unknown causes. However, had the Control worked, we expect to see the reproductive performance effects on diamondback moth.

TABLE G
Effect on the number of eggs (fecundity) of adult diamondback moth.

| | 1 DAT | | 2 DAT | |
|---|---|---|---|---|
| | No. of | No. of eggs per | No. of | No. of eggs per |
| Treatment | moth pairs | female moth | moth pairs | female moth |
| Control | 20 | 0 | 20 | 0.5 |
| Compound 1 | 16 | 0 | 16 | 2.2 |
| (10 ppm) | | | | |
| Compound 2 | 18 | 0 | 18 | 0.2 |
| (10 ppm) | | | | |

### Test H

For evaluating the reproductive performance effects on cotton bollworm (Helicoverpa armigera Hübner), each test unit consisted of one pair of adult (female and male) Helicoverpa armigera moths. To obtain the adult moths, male and female pupae of approximately the same age (±1 day) were placed in separate containers until adults emerged. After emergence, adult moths of about the same age (±1 day) were selected for testing. Ten adult moths of the same sex were placed in a cage containing a potted cotton plant in a 2.5-cm² container covered with sleeve of fine-mesh polyester material. Then the cages were sprayed over the top with designated treatments of the test compounds using a CO₂ sprayer fitted with a flat fan nozzle, calibrated to deliver about 200 mL (500 L/ha) of spray at a spray pressure of 207 kPa. The spray nozzle was placed 60 cm above the top of the cages.

Sub-lethal rates of Compound 1 on cotton bollworm were estimated based on a preliminary dose-response curve using rates of 10, 25, 50, 80 and 100 ppm. The LC₂₀ and LC₅₀ were determined to be 18 ppm and 33 ppm, respectively. Three treatments consisted of test solutions containing Compound 1 at 10, 20 and 30 ppm as well as a control sprayed with water without test compound.

The treated adult moths were transferred individually into a clean container made of a clear plastic cup covered with cloth and supplied with a cotton wick soaked in 10% sucrose solution as adult diet source. Each treatment used 10 adult females and 10 adult males (i.e. 10 replicates per treatment). One day after treatment, a pair of treated adults (male and female) were placed together in a cage made of a 300 mL clear plastic cup with screened cloth cover and containing a source of adult diet, allowing the moths to copulate. Each pair of moths was transferred to a new cup daily. The number of eggs laid was counted daily for about 10 days (which is the period during which female moths typically produce viable eggs) and totaled. To evaluate the viability of eggs, the copulation cages containing eggs were stored in a growth chamber at 24-27° C. with 14 hours of light per day and 70% relative humidity. The number of eggs hatched was counted daily for 10 days after treatment (DAT), and then totaled as listed in Table H.

TABLE H
Total number of eggs laid and number of successful egg hatched.

| | | No. of |
|---|---|---|
| Compound, Rate | No. of eggs laid | eggs hatched |
| Control | 3031 | 1293 |
| Compound 1, 10 ppm | 3412 | 977 |
| Compound 1, 20 ppm | 1180 | 778 |
| Compound 1, 30 ppm | 4920 | 84 |

The data indicate that while treatments of Compound 1 in sub-lethal, reproductive-disruptive concentrations did not consistently reduce the number of eggs laid under the conditions of this test, these concentrations did progressively substantially decrease the number of eggs hatched of cotton bollworm as compared to controls.

What is claimed is:

1. A method for disrupting reproductive performance of an adult arthropod pest comprising contacting the adult arthropod pest or its environment with a sub-lethal, reproduction-disruptive amount of a carboxamide arthropodicide, its N-oxide, or a salt thereof, provided that the adult arthropod pest is other than Cydia pomonella or Grapholita molesta.

2. The method of claim 1 wherein the carboxamide arthropodicide is selected from anthranilamides of Formula 1, N-oxides, and salts thereof, 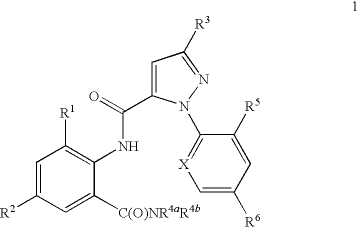
wherein
X is N, CF, CCl, CBr or CT;
R¹ is CH₃, Cl, Br or F;
R² is H, F, Cl, Br or CN;
R³ is F, Cl, Br, C₁-C₄ haloalkyl or C₁-C₄ haloalkoxy;
R^{4a} is H, C₁-C₄ alkyl, cyclopropylmethyl or 1-cyclopropylethyl;
R^{4b} is H or CH₃;
R⁵ is H, F, Cl or Br; and
R⁶ is H, F, Cl or Br.

3. The method of claim 2 wherein X is N; R¹ is CH₃; R² is Cl or CN; R³ is Cl, Br or CF₃; R^{4a} is C₁-C₄ alkyl; R^{4b} is H; R⁵ is Cl; and R⁶ is H.

4. The method of claim 3 wherein X is N; R¹ is CH₃; R² is Cl or CN; R³ is Cl, Br or CF₃; R^{4a} is Me or CH(CH₃)₂; R^{4b} is H; R⁵ is Cl; and R⁶ is H.

5. The method of claim 1 wherein the carboxamide arthropodicide is selected from phthalic diamides of Formula 2 and salts thereof, 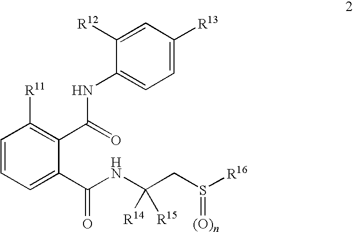
wherein
R¹¹ is CH₃, Cl, Br or I;
R¹² is CH₃ or Cl;
R¹³ is C₁-C₃ fluoroalkyl;
R¹⁴ is H or CH₃;
R¹⁵ is H or CH₃;
R¹⁶ is C₁-C₂ alkyl; and
n is 0, 1 or 2.

6. The method of claim 5 wherein R¹¹ is Cl, Br or I; R¹² is CH₃; R¹³ is CF₃, CF₂CF₃ or CF(CF₃)₂; R¹⁴ is H or CH₃; R¹⁵ is H or CH₃; R¹⁶ is CH₃; and n is 0, 1 or 2.

7. The method of claim 1 wherein the carboxamide arthropodicide is selected from:
N-[4-chloro-2-methyl-6-[[(1-methylethyl)amino]carbonyl]phenyl]-1-(3-chloro-2-pyridinyl)-3-(trifluoromethyl)-1H-pyrazole-5-carboxamide,
N-[4-chloro-2-methyl-6-[(methylamino)carbonyl]phenyl]-1-(3-chloro-2-pyridinyl)-3-(trifluoromethyl)-1H-pyrazole-5-carboxamide,
3-bromo-N-[4-chloro-2-methyl-6-[[(1-methylethyl)amino]carbonyl]phenyl]-1-(3-chloro-2-pyridinyl)-1H-pyrazole-5-carboxamide,
3-bromo-N-[4-chloro-2-methyl-6-[(methylamino)carbonyl]phenyl]-1-(3-chloro-2-pyridinyl)-1H-pyrazole-5-carboxamide,
3-bromo-1-(3-chloro-2-pyridinyl)-N-[4-cyano-2-methyl-6-[(methylamino)-carbonyl]phenyl]-1H-pyrazole-5-carboxamide,
1-(3-chloro-2-pyridinyl)-N-[4-cyano-2-methyl-6-[(methylamino)carbonyl]-phenyl]-3-(trifluoromethyl)-1H-pyrazole-5-carboxamide,
3-bromo-1-(2-chlorophenyl)-N-[4-cyano-2-methyl-6-[[(1-methylethyl)amino]-carbonyl]phenyl]-1H-pyrazole-5-carboxamide,
3-bromo-1-(2-chlorophenyl)-N-[4-cyano-2-methyl-6-[(methylamino)carbonyl]-phenyl]-1H-pyrazole-5-carboxamide,
3-bromo-1-(2-chlorophenyl)-N-[2,4-dichloro-6-[(methylamino)carbonyl]-phenyl]-1H-pyrazole-5-carboxamide,
3-bromo-N-[4-chloro-2-[[(cyclopropylmethyl)amino]carbonyl]-6-methyl-phenyl]-1-(3-chloro-2-pyridinyl)-1H-pyrazole-5-carboxamide,
3-bromo-1-(3-chloro-2-pyridinyl)-N-[4-cyano-2-[[(cyclopropylmethyl)amino]-carbonyl]-6-methylphenyl]-1H-pyrazole-5-carboxamide,
3-bromo-N-[4-chloro-2-[[(1-cyclopropylethyl)amino]carbonyl]-6-methyl-phenyl]-1-(3-chloro-2-pyridinyl)-1H-pyrazole-5-carboxamide,
3-bromo-1-(3-chloro-2-pyridinyl)-N-[4-cyano-2-[[(1-cyclopropylethyl)amino]-carbonyl]-6-methylphenyl]-1H-pyrazole-5-carboxamide; and
N²-[1,1-dimethyl-2-(methylsulfonyl)ethyl]-3-iodo-N¹-[2-methyl-4-[1,2,2,2-tetrafluoro-1-(trifluoromethyl)ethyl]phenyl]-1,2-benzenedicarboxamide.

8. The method of claim 1 wherein the arthropod pest is a species of the order Hemiptera.

9. The method of claim 8 wherein the arthropod pest is at least one of the species in one of the families Aleyrodidae, Aphididae, and Cicadellidae.

10. The method of claim 9 wherein the arthropod pest is Bemisia argentifolii.

11. The method of claim 9 wherein the arthropod pest is Myzus persicae.

12. The method of claim 9 wherein the arthropod pest is Nephotettix virescens.

13. The method of claim 1 wherein the arthropod pest is a species of the order Thysanoptera.

14. The method of claim 13 wherein the species is in the family Thripidae.

15. The method of claim 13 wherein the arthropod pest is Frankliniella occidentalis.

16. The method of claim 1 wherein the arthropod pest is a species of the order Coleoptera.

17. The method of claim 16 wherein the arthropod pest is a species in the family Chrysomelidae.

18. The method of claim 16 wherein the arthropod pest is Leptinotarsa decemlineata.

19. The method of claim 1 wherein the arthropod pests is a species of the order Lepidoptera.

20. The method of claim 19 wherein the arthropod pest is a species in one of the families Noctuidae and Plutellidae.

21. The method of claim 19 wherein the arthropod pest is Spodoptera exigua.

22. The method of claim 19 wherein the arthropod pest is Plutella xylostella.

23. The method of claim 19 wherein the arthropod pest is Helicoverpa armigera.

24. The method of claim 1 wherein the arthropod pest is a species of the order Diptera.

25. The method of claim 24 wherein the arthropod pest is a species in one of the families Tephritidae and Muscidae.

26. The method of claim 24 wherein the arthropod pest is Musca domestica.

27. The method of claim 1 wherein the carboxamide arthropodicide, its N-oxide, or a salt thereof, is formulated as a composition comprising the arthropodicide, its N-oxide, or a salt thereof, and at least one additional component selected from the group consisting of surfactants and liquid diluents.
